(19) United States
(12) Patent Application Publication
(10) Pub. No.: US 2025/0332791 A1
(43) Pub. Date: Oct. 30, 2025

(54) THREE-DIMENSIONAL SHAPING DEVICE

(71) Applicant: SEIKO EPSON CORPORATION, Tokyo (JP)

(72) Inventors: Yugo ISHIKAWA, SHIOJIRI-SHI (JP); Taki HASHIMOTO, SHIOJIRI-SHI (JP)

(21) Appl. No.: 19/184,106

(22) Filed: Apr. 21, 2025

(30) Foreign Application Priority Data
Apr. 24, 2024 (JP) 2024-070361

(51) Int. Cl. B29C 64/35; B29C 64/106; B29C 64/209; B29C 64/321; B29K 105/00; B33Y 30/00

(52) U.S. Cl. CPC B29C 64/35; B29C 64/106; B29C 64/209; B29C 64/321; B29K 2105/0094; B33Y 30/00

(57) ABSTRACT

A three-dimensional shaping device includes a nozzle configured to eject a shaping material, a discharging control mechanism provided in a flow path and configured to vary a degree of opening of the flow path, a suction-feeding unit configured to perform a suction and feeding manipulations, the suction manipulation being a manipulation of sucking the shaping material within the flow path into a branch flow path coupled to the flow path between the discharging control mechanism and the ejection port, the feeding manipulation being a manipulation of feeding, to the flow path, the shaping material sucked into the branch flow path, and a control unit configured to control the discharging control mechanism to stop supplying the shaping material, and to perform a cleaning process. During the cleaning process, the suction manipulation is performed, to emit at least a portion of the shaping material within the nozzle, to a non-shaping region.

The present application is based on, and claims priority from JP Application Serial Number 2024-070361, filed Apr. 24, 2024, the disclosure of which is hereby incorporated by reference herein in its entirety.

### BACKGROUND

### 1. Technical Field

The present disclosure relates to a three-dimensional shaping device.

### 2. Related Art

JP-T-2010-530326 disclosures a three-dimensional shaping device including an end-portion cleaning assembly including a flicker plate and a brush. In this three-dimensional shaping device, the pushing head is caused to come into contact with the flicker plate and the brush to clean the pushing head.

When the top end of the nozzle included in the three-dimensional shaping device is cleaned using the cleaning member such as the flicker plate or the brush, there is a possibility that the waste material attached on the cleaning member is attached on the nozzle again.

### SUMMARY

A first mode according to the present disclosure provides a three-dimensional shaping device. This three-dimensional shaping device includes a nozzle including an ejection port configured to eject a shaping material toward a stage where a three-dimensional shaped article is shaped, a discharging control mechanism provided in a flow path through which the shaping material flows, and configured to vary a degree of opening of the flow path to control a supply amount of the shaping material to the nozzle, a suction-feeding unit configured to perform a suction manipulation and a feeding manipulation, the suction manipulation being a manipulation of sucking the shaping material within the flow path into a branch flow path coupled to the flow path between the discharging control mechanism and the ejection port, the feeding manipulation being a manipulation of feeding, to the flow path, the shaping material sucked into the branch flow path, and a control unit configured to control the discharging control mechanism in a state where the shaping material is ejected from the nozzle, to stop supplying the shaping material to the nozzle, and then, perform a cleaning process, in which during the cleaning process, the control unit controls the suction-feeding unit to perform the suction manipulation, to emit at least a portion of the shaping material within the nozzle, to a non-shaping region where the three-dimensional shaped article is not shaped.

### BRIEF DESCRIPTION OF THE DRAWINGS

FIG. 1 is a diagram used to describe the schematic configuration of a three-dimensional shaping device.

FIG. 2 is a diagram used to describe the schematic configuration of the three-dimensional shaping device.

FIG. 3 is a perspective view illustrating the schematic configuration of a screw.

FIG. 4 is a schematic plan view illustrating a barrel.

FIG. 5 is a perspective view illustrating a cleaning mechanism.

FIG. 6 is a side view illustrating the cleaning mechanism.

FIG. 7 is a perspective view illustrating a cleaning unit.

FIG. 8 is a perspective view illustrating the cleaning unit.

FIG. 9 is a diagram used to describe a state where the bottom surface of an accommodation unit turns into an open state.

FIG. 10 is a diagram used to describe a state where a waste material drops to a collecting unit.

FIG. 11 is a flowchart of a material emitting process that a control unit performs.

FIG. 12 is a first explanatory diagram illustrating an operating state of an ejecting unit.

FIG. 13 is a perspective view illustrating a discharging control mechanism.

FIG. 14 is an image obtained by capturing a state where a shaping material is being ejected.

FIG. 15 is a second explanatory diagram illustrating an operating state of the ejecting unit.

FIG. 16 is an image obtained by capturing a state where a shaping material is being ejected.

FIG. 17 is an image obtained by capturing an ejecting state of a shaping material.

FIG. 18 is a third explanatory diagram illustrating an operating state of the ejecting unit.

FIG. 19 is an image obtained by capturing a state where a shaping material is being sucked.

FIG. 20 is an image obtained by capturing a state where a shaping material is being sucked.

FIG. 21 is a diagram used to describe a state within a nozzle.

FIG. 22 is a diagram showing examples of the shaping material.

### DESCRIPTION OF EMBODIMENTS

### A. First Embodiment

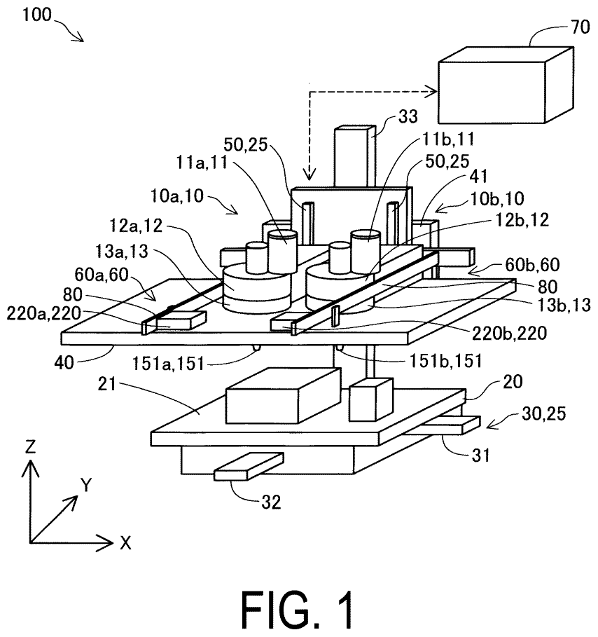

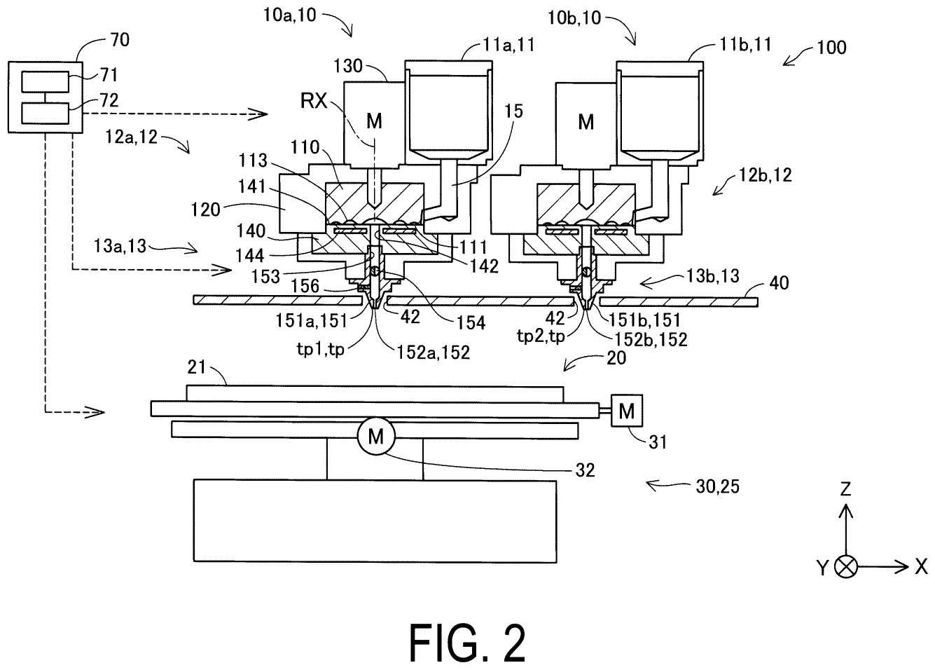

FIGS. 1 and 2 are diagrams used to describe the schematic configuration of a three-dimensional shaping device 100 according to a first embodiment. In FIGS. 1 and 2, arrows indicating X, Y, and Z directions that are perpendicular to each other are illustrated. The X direction and the Y direction are directions parallel to the horizontal surface, and the Z direction is a direction extending along the vertically upward direction. The arrows indicating the X, Y, and Z directions are also provided in other drawings such that the directions in the drawings correspond to those illustrated in FIGS. 1 and 2 as appropriate. In the following description, when directions are specified, the direction indicated by the arrow in each of the drawings is referred to as “+”, and the direction opposite to this direction is referred to as “−”, whereby positive and negative signs are used in combination with the direction notions. Hereinafter, the +Z direction is also referred as “up”, and the −Z direction is also referred to as “down”.

The three-dimensional shaping device 100 according to the present embodiment is a device configured to shape a shaped article through a material extrusion method. The three-dimensional shaping device 100 includes a head 10 including a nozzle 151, a stage 20, a position changing unit 25, a heating unit 40, a head lifting mechanism 50, a cleaning mechanism 60 including a cleaning unit 220, and a control unit 70. Note that neither the head lifting mechanism 50 nor the cleaning mechanism 60 is illustrated in FIG. 2.

The control unit 70 is a control device configured to control the entire operations of the three-dimensional shaping device 100. As illustrated in FIG. 2, the control unit 70 is comprised of a computer including a CPU 71, a storage device 72, and an input-output interface configured to input and output a signal with the outside. The control unit 70 performs a function in which the CPU 71 implements a program or instruction read on the main storage device to perform a shaping process for shaping a three-dimensional shaped article, and also performs a function of performing a material emitting process that will be described later. Note that, in other embodiments, the control unit 70 may be achieved by a configuration in which a plurality of circuits for achieving at least a portion of the individual functions are combined, instead of being comprised of a computer.

In a shaping process, the control unit 70 shapes a three-dimensional shaped article in accordance with shaping data used to shape the three-dimensional shaped article. The shaping data includes path information indicating a movement path of the nozzle 151, and ejection amount information indicating the ejection amount of plasticizing material for each movement path, for each layer obtained by slicing the shape of the shaped article into a plurality of pieces.

Under control by the control unit 70, the head 10 illustrated in FIGS. 1 and 2 ejects a shaping material used to shape a three-dimensional shaped article on the stage 20 serving as a base for the three-dimensional shaped article. In the present embodiment, the shaping material is a plasticizing material obtained by plasticizing a material in a solid state into a paste form as described later. The head 10 includes a material supply unit 11, a plasticizing unit 12, and an ejecting unit 13.

The three-dimensional shaping device 100 includes a first head 10a and a second head 10b as the head 10. The first head 10a includes a first material supply unit 11a as the material supply unit 11, includes a first plasticizing unit 12a as the plasticizing unit 12, and includes a first ejecting unit 13a as the ejecting unit 13. The second head 10b includes a second material supply unit 11b as the material supply unit 11, includes a second plasticizing unit 12b as the plasticizing unit 12, and includes a second ejecting unit 13b as the ejecting unit 13. The first head 10a and the second head 10b are disposed so as to be arrayed in the X direction such that positions thereof in the Y direction align with each other. The second head 10b is disposed at the +X direction side of the first head 10a. The first head 10a has a configuration similar to the configuration of the second head 10b. Thus, hereinafter, these heads may be referred to simply as the head 10 when they are not particularly distinguished from each other. In addition, when their component members are distinguished, a character “a” is attached to component members of the first head 10a, and a character “b” is attached to component members of the second head 10b.

The material supply unit 11 supplies the plasticizing unit 12 with a material used to generate a shaping material. The material supply unit 11 is comprised of a hopper, for example. The material supply unit 11 accommodates a pellet-form or powder-form material. The material includes, for example, thermoplastic resin such as polypropylene resin (PP), polylactic acid (PLA), polyethylene resin (PE), or polyacetal resin (POM).

The material accommodated in the first material supply unit 11a and the material accommodated in the second material supply unit 11b may be the same type of material, or may be different types of material.

A communicating path 15 configured to couple the material supply unit 11 and the plasticizing unit 12 is provided below the material supply unit 11. The material supply unit 11 supplies the plasticizing unit 12 with the material through the communicating path 15.

The plasticizing unit 12 plasticizes at least a portion of the material supplied from the material supply unit 11 to generate a shaping material in a paste form having fluidity, and guide it to the ejecting unit 13. The term “plasticize” is a concept including melting, and means changing a solid into a state having fluidity. Specifically, in a case of a material in which glass transition occurs, “plasticize” means making the material have a temperature equal to or more than the glass transition point. In a case of a material in which glass transition does not occurs, “plasticize” means making the material have a temperature equal to or more than the melting point.

The plasticizing unit 12 includes a screw 110, a screw case 120, a drive motor 130, and a barrel 140.

The screw 110 is accommodated in the screw case 120. The upper face side of the screw 110 is coupled to the drive motor 130. The screw 110 rotates within the screw case 120 with rotary drive force generated by the drive motor 130. The direction of the axial line of the screw rotary axis RX serving as a rotary axis of the screw 110 is the Z direction. The rotational speed of the screw 110 is controlled by the control unit 70 controlling the rotational speed of the drive motor 130. Note that the screw 110 may be driven by the drive motor 130 through a speed reducer. The screw 110 is also called a rotor or a flat screw.

The barrel 140 is disposed at the −Z direction side of the screw 110. An opposing surface 141 serving as the upper surface of the barrel 140 is opposed to a groove formation surface 111 serving as the lower surface of the screw 110. A communication hole 142 that communicates with a flow path 153 of the ejecting unit 13 is formed at the center of the barrel 140. A plasticizing heater 144 is provided within the barrel 140. The temperature of the plasticizing heater 144 is controlled by the control unit 70.

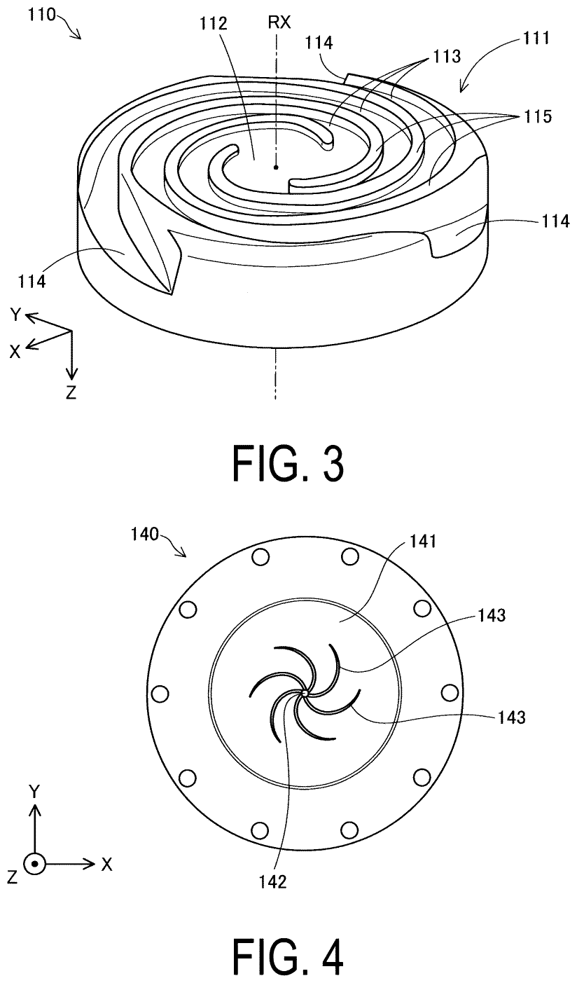

FIG. 3 is a perspective view illustrating the schematic configuration of the screw 110. The screw 110 has a substantially cylindrical shape in which the length in a direction along the screw rotary axis RX is smaller than the length in a direction perpendicular to the screw rotary axis RX. A groove 113 having a spiral shape is formed at the groove formation surface 111 with a central portion 112 being the center. The groove 113 communicates with a material inserting port 114 formed at the side surface of the screw 110. The material supplied from the material supply unit 11 flows though the material inserting port 114 to be supplied to the groove 113. The groove 113 is formed so as to be separated by a raised ridge portion 115. FIG. 3 illustrates an example in which three grooves 113 are formed. However, the number of grooves 113 may be one or may be two or more. Note that the shape of the groove 113 is not limited to the spiral shape. The shape may be a helical shape or involute curve shape, or may be a shape extending along an arc shape from the central portion 112 toward the outer periphery.

FIG. 4 is a schematic plan view illustrating the barrel 140. A plurality of guide grooves 143 are formed around the communication hole 142 at the opposing surface 141. Each of the guide grooves 143 has one end coupled to the communication hole 142, and extends in a spiral shape from the communication hole 142 toward the outer periphery of the opposing surface 141. Note that one end of the guide groove 143 may not be coupled to the communication hole 142. In addition, the guide groove 143 may not be formed in the barrel 140.

The material supplied to the groove 113 of the screw 110 flows along the groove 113 while being plasticized within the groove 113 due to the rotation of the screw 110 and heat of the plasticizing heater 144, and is guided to the center portion 112 of the screw 110 as the shaping material. The shaping material in a paste form that has flown into the central portion 112 and has fluidity is supplied to the ejecting unit 13 through the communication hole 142. Note that, in the plasticizing unit 12, not all types of substances that constitute the shaping material may be plasticized. It is only necessary that the shaping material is plasticized into a state of having fluidity as a whole by plasticizing at least a portion of types of substances of the substances that constitute the shaping material.

The ejecting unit 13 ejects the shaping material. The ejecting unit 13 includes the nozzle 151, the flow path 153, a discharging control mechanism 154, and a suction-feeding unit 156.

The nozzle 151 is coupled to the communication hole 142 of the barrel 140 through the flow path 153. The nozzle 151 ejects the shaping material generated in the plasticizing unit 12, toward the stage 20 from an ejection port 152 formed at a tip portion tp of the nozzle 151. More specifically, a first nozzle 151a ejects the shaping material from a first ejection port 152a formed at a first tip portion tp1. A second nozzle 151b ejects the shaping material from a second ejection port 152b formed at a second tip portion tp2.

The discharging control mechanism 154 is provided in the flow path 153. By varying the degree of opening of the flow path 153, the discharging control mechanism 154 controls the supply amount of the shaping material to the nozzle 151. In the present embodiment, the discharging control mechanism 154 is comprised of a valve, and rotates within the flow path 153 to vary the opening area of the flow path 153. The discharging control mechanism 154 is driven by a driven unit (not illustrated) under control by the control unit 70. The driving unit that causes the discharging control mechanism 154 to drive is comprised of a stepping motor, for example. The control unit 70 is able to control the rotational angle of a valve to adjust the volume of flow of the shaping material flowing through the nozzle 151 from the plasticizing unit 12, that is, adjust the ejection amount of the shaping material ejected from the nozzle 151. The discharging control mechanism 154 is able to adjust the ejection amount of the shaping material, and at the same time, is able to control ON/OFF of the flowing of the shaping material. Note that it is only necessary that the valve has a shape that rotates within the flow path 153 to adjust the degree of opening of the flow path 153, and the shape of the valve may be a plate shape or half-sphere shape. In addition, in other embodiments, the discharging control mechanism 154 may be configured as a piston mechanism configured to adjust the degree of opening of the flow path 153 by the operation of a piston, or a shutter mechanism configured to adjust the degree of opening of the flow path 153 by opening and closing a shutter, for example.

The suction-feeding unit 156 is coupled to the flow path 153 between the discharging control mechanism 154 and the ejection port 152. The detailed configuration of the suction-feeding unit 156 will be described later. The control unit 70 controls the suction-feeding unit 156 to perform a suction manipulation of sucking the shaping material within the flow path 153, and also perform a feeding manipulation of feeding the sucked shaping material to the flow path 153. When a shaping process of shaping a three-dimensional shaped article is performed, the control unit 70 performs the suction manipulation at the time of reducing the movement velocity of the nozzle 151, and performs the feeding manipulation at the time of increasing the movement velocity of the nozzle 151 again after the velocity reduction, for example. With this configuration, the control unit 70 suppresses a variation of line width of the shaping material at the time of increasing and reducing the velocity of the nozzle 151.

The stage 20 is disposed at a position that is opposed to the ejection port 152 of the nozzle 151. The three-dimensional shaping device 100 ejects the shaping material from the nozzle 151 to a shaping surface 21 serving as the upper surface of the stage 20 to stack shaping layers, thereby shaping a three-dimensional shaped article. A region on the shaping surface 21 where the three-dimensional shaped article is shaped is also referred to as a shaping region. In addition, a direction in which the shaping material is stacked at the shaping surface 21 is also referred to as a stacking direction.

The position changing unit 25 changes relative positions of the ejecting unit 13, the stage 20, and the cleaning unit 220. As illustrated in FIG. 1, the position changing unit 25 according to the present embodiment includes a stage movement unit 30 and the head lifting mechanism 50.

The stage movement unit 30 changes relative positions of the ejecting unit 13 and the stage 20. The stage movement unit 30 includes a first electrically powered actuator 31 configured to move the stage 20 along the X direction, a second electrically powered actuator 32 configured to move the stage 20 and the first electrically powered actuator 31 along the Y direction, and the third electrically powered actuator 33 configured to move the head 10 along the Z direction. The third electrically powered actuator 33 moves, along the Z direction, a plate-shape movable unit 41 at which the first head 10a, the second head 10b, and the cleaning unit 220 are fixed, thereby moving the first head 10a, the second head 10b, and the cleaning unit 220 along the Z direction. The first electrically powered actuator 31, the second electrically powered actuator 32, and the third electrically powered actuator 33 are driven under control by the control unit 70. Note that neither the third electrically powered actuator 33 nor the movable unit 41 is illustrated in FIG. 2.

In other embodiments, the stage movement unit 30 may move the stage 20 in the Z direction to move the first head 10a and the second head 10b along the X direction and the Y direction, for example. The stage movement unit 30 may move the stage 20 in the X direction, the Y direction, and the Z direction without moving the first head 10a or the second head 10b. The stage movement unit 30 may move the first head 10a and the second head 10b in the X direction, the Y direction, and the Z direction without moving the stage 20.

The head lifting mechanism 50 moves the head 10 in the Z direction relative to the cleaning unit 220. Note that, by moving the head 10 by the head lifting mechanism 50, it is possible to change the relative positions of the ejecting unit 13 and the cleaning unit 220 in the Z direction, and also change relative positions of the ejecting unit 13 of the stage 20 in the Z direction. The three-dimensional shaping device 100 includes two head lifting mechanisms 50 provided so as to correspond to the first head 10a and the second head 10b. In the present embodiment, one of the head lifting mechanisms 50 moves the first head 10a in the Z direction, and the other one of the head lifting mechanisms 50 moves the second head 10b in the Z direction. Each of the head lifting mechanisms 50 is fixed to the movable unit 41, and is moved together with the head 10 and the cleaning mechanism 60 in the Z direction by the third electrically powered actuator 33. Each of the head lifting mechanisms 50 is configured, for example, as an electrically powered actuator, and is individually driven under control by the control unit 70. Note that the head lifting mechanisms 50 are not illustrated in FIG. 2.

The heating unit 40 heats the shaping material stacked at the stage 20. The heating unit 40 has a plate shape, and includes a heater. Two arm portions 80 extending along the Y direction are fixed to the movable unit 41. The heating unit 40 is hung from the two arm portions 80, thereby being supported so as to be opposed to the shaping surface 21. That is, the heating unit 40 is fixed to the movable unit 41 through the two arm portions 80. The heating unit 40 together with the head 10 fixed to the movable unit 41 is moved in the Z direction by the third electrically powered actuator 33. Thus, the heating unit 40 together with the first head 10a and the second head 10b changes its relative position with respect to the stage 20.

As illustrated in FIG. 2, the heating unit 40 includes an opening 42 penetrating through the heating unit 40 in the Z direction. More specifically, the heating unit 40 includes two openings 42 so as to correspond to the first nozzle 151a and the second nozzle 151b.

In the present embodiment, the first nozzle 151a and the second nozzle 151b are each configured so as to be able to switch between a shaping state and a retracted state by the head lifting mechanism 50. The shaping state represents a state where the ejection port 152 is disposed between the heating unit 40 and the stage 20 in the Z direction. In the shaping state, at least a portion of the nozzle 151 is disposed within the opening 42. The nozzle 151 is in the shaping state at least at the time of shaping. The “at the time of shaping” represents timing at which the shaping material is ejected to the shaping region in order to shape a shaping layer. In FIGS. 1 and 2, the first nozzle 151a and the second nozzle 151b are in the shaping state. The retracted state represents a state where the ejection port 152 is disposed at an upper side than the heating unit 40. In the retracted state, the nozzle 151 is disposed outside of the opening 42. When the nozzle 151 is switched from the shaping state to the retracted state, the head lifting mechanism 50 moves the head 10 toward the +Z direction. When the nozzle 151 is switched from the retracted state to the shaping state, the head lifting mechanism 50 moves the head 10 toward the −Z direction.

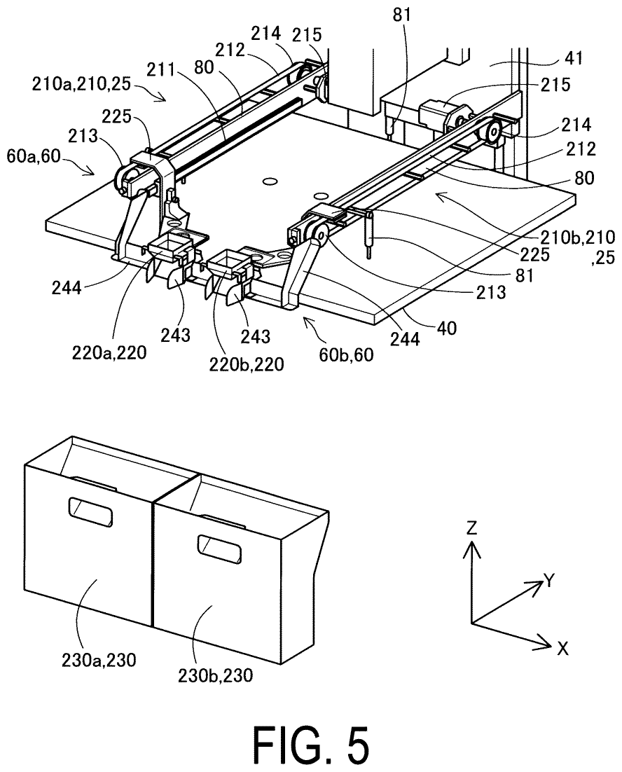

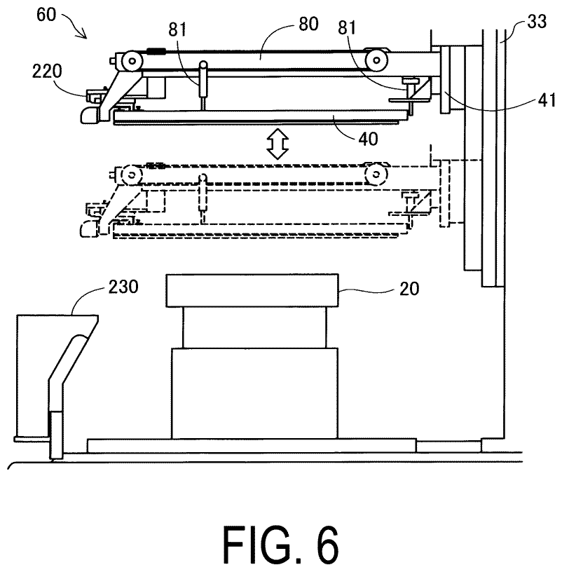

FIG. 5 is a perspective view illustrating the cleaning mechanism 60. FIG. 6 is a side view illustrating the cleaning mechanism 60. In the present embodiment, the cleaning mechanism 60 is attached to the arm portion 80. The heating unit 40 is hung from the arm portion 80 using a hanging member 81. Thus, as illustrated in FIG. 6, as the movable unit 41 to which the arm portion 80 is fixed is driven by the third electrically powered actuator 33, the cleaning mechanism 60 together with the heating unit 40 is moved in the Z direction.

The cleaning mechanism 60 is a mechanism used to clean the nozzle 151. As illustrated in FIG. 5, the cleaning mechanism 60 includes a cleaning movement unit 210 and the cleaning unit 220. In the present embodiment, the cleaning mechanism 60 includes a first cleaning mechanism 60a and a second cleaning mechanism 60b. The first cleaning mechanism 60a includes a first cleaning movement unit 210a as the cleaning movement unit 210, and includes a first cleaning unit 220a as the cleaning unit 220. The second cleaning mechanism 60b includes a second cleaning movement unit 210b as the cleaning movement unit 210, and includes a second cleaning unit 220b as the cleaning unit 220. The first cleaning mechanism 60a cleans the first nozzle 151a, and the second cleaning mechanism 60b cleans the second nozzle 151b. A collecting unit 230 used to collect a waste material emitted from the nozzle 151 by the cleaning mechanism 60 is disposed below the cleaning unit 220. The collecting unit 230 includes a first collecting unit 230a and a second collecting unit 230b. The first collecting unit 230a is disposed below the first cleaning unit 220a. The second collecting unit 230b is disposed below the second cleaning unit 220b. The first cleaning mechanism 60a and the second cleaning mechanism 60b have a similar configuration. When their component members are distinguished, a character “a” is attached to component members of the first cleaning mechanism 60a, and a character “b” is attached to component members of the second cleaning mechanism 60b.

The cleaning movement unit 210 moves the cleaning unit 220 relatively to the nozzle 151. The cleaning movement unit 210 also constitutes a portion of the position changing unit 25. The cleaning movement unit 210 is fixed to the arm portion 80. The cleaning movement unit 210 includes a driving belt 212, a first pulley 213, a second pulley 214, and a belt driving unit 215. The first pulley 213 is provided at an end portion, at the −Y direction side, of the arm portion 80. The second pulley 214 is provided at an end portion, at the +Y direction side, of the arm portion 80. The driving belt 212 is looped between the first pulley 213 and the second pulley 214. The belt driving unit 215 rotationally drives the second pulley 214 to drive the driving belt 212. The belt driving unit 215 is configured, for example, as a motor, and is controlled by the control unit 70.

The cleaning unit 220 is coupled to the driving belt 212 through a coupling portion 225. The coupling portion 225 is configured so as to be able to move in the Y direction along a guide rail 211 attached to the arm portion 80. Thus, with the driving belt 212 being driven by the belt driving unit 215, the cleaning unit 220 moves in the Y direction along the guide rail 211. With such a configuration, the cleaning unit 220 is moved by the cleaning movement unit 210 relatively to the nozzle 151.

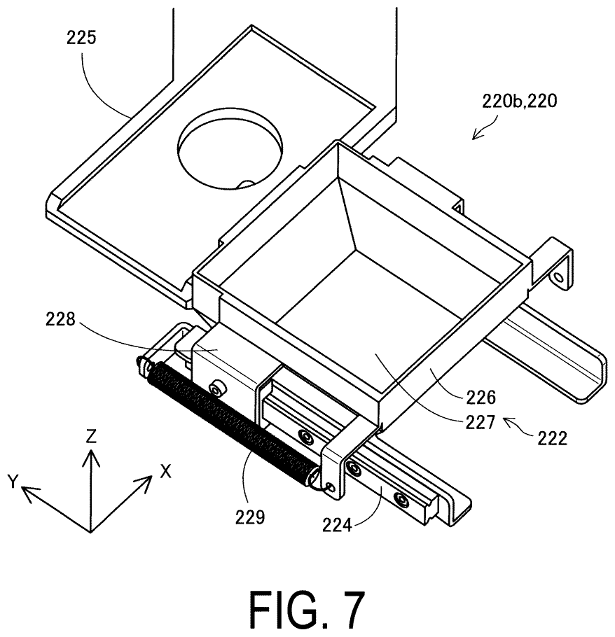

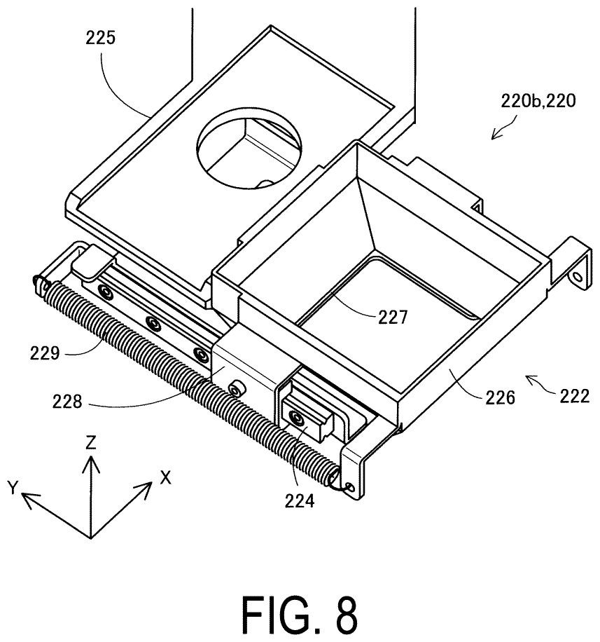

FIGS. 7 and 8 are perspective views illustrating the cleaning unit 220. FIGS. 7 and 8 illustrate the second cleaning unit 220b of the cleaning unit 220. The second cleaning unit 220b and the first cleaning unit 220a have structures that are symmetrical with respect to the Y-axis. The cleaning unit 220 includes an accommodation unit 222.

The accommodation unit 222 includes a tubular-shape main body 226, and a bottom surface 227 disposed at the bottom of the main body 226. The main body 226 is attached to the coupling portion 225. The accommodation unit 222 accommodates a waste material emitted from the nozzle 151 through a material emitting process that will be described later.

The bottom surface 227 of the accommodation unit 222 is configured so as to be able to open and close. The main body 226 and the bottom surface 227 that constitute the accommodation unit 222 are able to relatively move in a sliding manner in the Y direction. As a slide member 228 coupled to the main body 226 moves in the Y direction along a slide rail 224 coupled to the bottom surface 227, the bottom surface 227 opens and closes. A spring 229 is disposed between an end portion, at the −Y direction, of the main body 226 and an end portion, at the +Y direction, of the bottom surface 227. The main body 226 and the bottom surface 227 are usually pulled to each other with the spring 229, whereby the bottom surface 227 is positioned at the bottom of the main body 226, as illustrated in FIG. 7. This makes the bottom surface 227 in a closed state. In contrast, when the main body 226 and the bottom surface 227 move so as to be spaced apart from each other, the spring 229 is pulled, and the bottom surface 227 is moved toward the +Y direction relatively to the main body 226, whereby the bottom surface 227 turns into a state where the bottom surface 227 does not exist at the bottom of the main body 226, as illustrated in FIG. 8. This makes the bottom surface 227 into an open state.

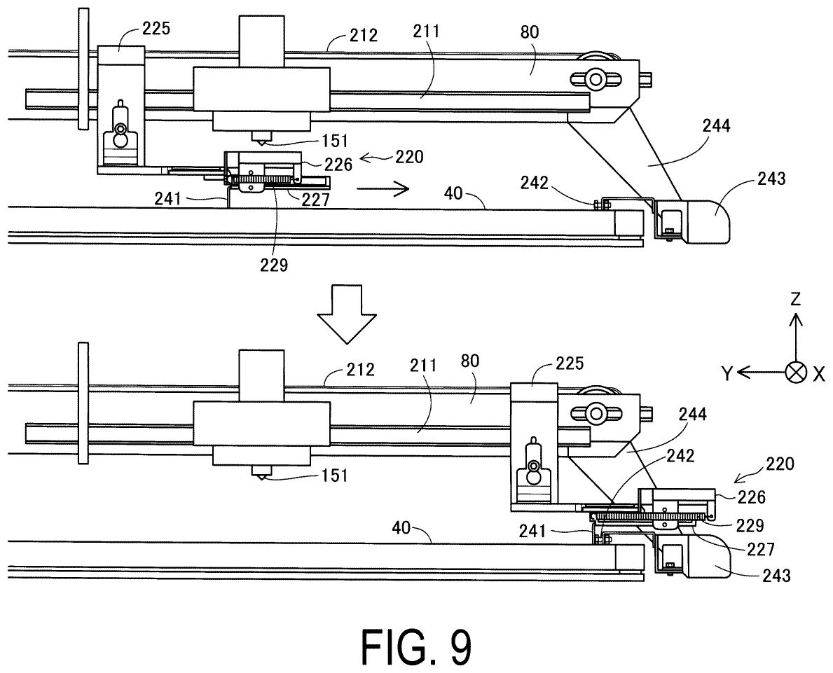

FIG. 9 is a diagram used to describe a state where the bottom surface 227 of the accommodation unit 222 is in the open state. After a waste material is accommodated in the cleaning unit 220, the control unit 70 controls the cleaning movement unit 210 to perform a movement manipulation of moving, in the horizontal direction, the cleaning unit 220 from a position corresponding to the nozzle 151 toward an emission position corresponding to the collecting unit 230. The upper section of FIG. 9 illustrates a state where the cleaning unit 220 is disposed at a position corresponding to the nozzle 151, and the lower section of FIG. 9 illustrates a state where the cleaning unit 220 is disposed at the emission position corresponding to the collecting unit 230.

As the cleaning unit 220 moves toward the emission position, a contact member 241 coupled to the bottom surface 227 comes into contact with a fixing member 242 coupled to the arm portion 80. After the contact member 241 coupled to the bottom surface 227 comes into contact with the fixing member 242 coupled to the arm portion 80, the contact member 241 interferes with the fixing member 242 when the cleaning movement unit 210 moves the cleaning unit 220 toward the −Y direction. Thus, the bottom surface 227 provided with the contact member 241 stops there, and only the main body 226 of the accommodation unit 222 moves in a sliding manner toward the emission position while pulling the spring 229. In this manner, as the main body 226 moves in a sliding manner relatively to the bottom surface 227, the bottom surface 227 turns into the open state, and at the emission position, a waste material drops from the accommodation unit 222 toward the collecting unit 230.

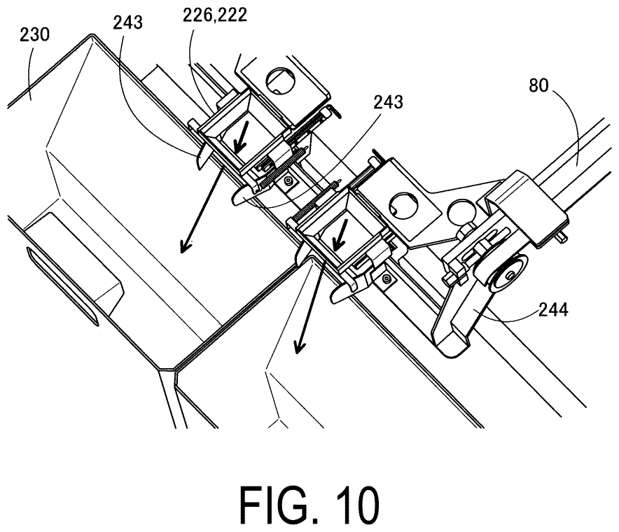

FIG. 10 is a diagram used to describe a state where a waste material drops to the collecting unit 230. As illustrated in FIGS. 5, 9, and 10, a guiding portion 243 used to turn, to the collecting unit 230, the direction in which the waste material drops is provided below the accommodation unit 222 disposed at the emission position. The guiding portion 243 is fixed to the arm portion 80 through a guide support portion 244. The waste material slides downward through the guiding portion 243 and drops into the collecting unit 230. In the present embodiment, two guiding portions 243 are fixed to the arm portion 80 so as to correspond to the first cleaning unit 220a and the second cleaning unit 220b. Thus, a waste material collected by the first cleaning unit 220a is appropriately emitted to the first collecting unit 230a, whereas a waste material collected by the second cleaning unit 220b is appropriately emitted to the second collecting unit 230b. For this reason, when different shaping materials are ejected from the first head 10a and the second head 10b, it is possible to appropriately collect the waste material for each of the shaping materials, which allows the shaping materials to be easily reused. Note that the number of collecting units 230 may be one.

The fixing member 242 illustrated in FIG. 9 is attached to the guiding portion 243 supported by the arm portion 80. That is, the guiding portion 243 and the fixing member 242 are fixed to the movable unit 41 through the arm portion 80, rather than the heating unit 40. Thus, vibration occurring when the contact member 241 included in the bottom surface 227 of the accommodation unit 222 comes into contact with the fixing member 242 attached to the guiding portion 243 does not have direct influence on the heating unit 40. This makes it possible to suppress a reduction in the degree of parallelization of the heating unit 40 relative to the shaping surface 21 due to the vibration.

In the present embodiment, the fixing member 242 is comprised of a bolt. Thus, by adjusting the attachment position of the fixing member 242 relative to the guiding portion 243 in accordance with the degree of fixing of the bolt, it is possible to adjust the contact position between the fixing member 242 and the contact member 241. This makes it possible to make fine adjustment of a position at which the cleaning unit 220 drops the waste material.

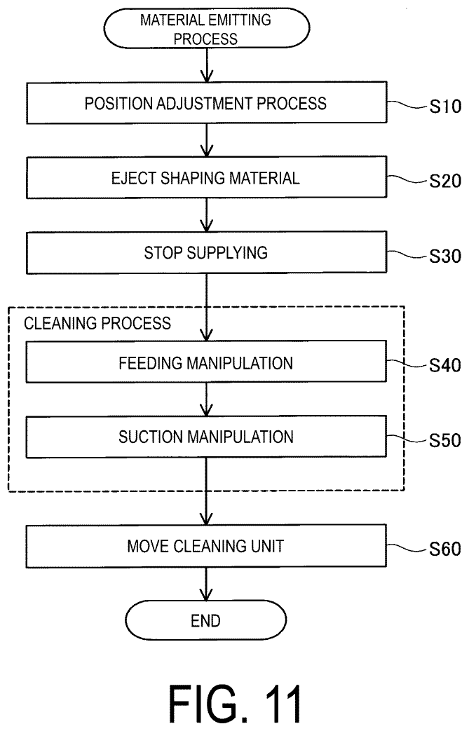

FIG. 11 shows a flowchart of a material emitting process performed by the control unit 70. This material emitting process is performed at predetermined timing during a time when a three-dimensional shaped article is being shaped. The timing of performing the material emitting process is determined, for example, on the basis of an elapsed time during shaping, the number of shaping layers that are shaped, and the amount of shaping material ejected from the nozzle 151. The timing of performing the material emitting process may be determined for each nozzle 151.

In step S10, the control unit 70 performs a position adjustment process of adjusting the height of the nozzle 151 to be cleaned and the initial position of the cleaning unit 220. In the following description concerning the material emitting process, the “nozzle 151” represents the “nozzle 151 to be cleaned”, unless otherwise specified. In the position adjustment process, the control unit 70 controls the head lifting mechanism 50 to turn the nozzle 151 into the retracted state. The control unit 70 adjusts the height position of the nozzle 151 such that, in the retracted state of the nozzle 151, the distance between the bottom surface 227 of the cleaning unit 220 and the nozzle 151 is a predetermined distance. Below, this distance is referred to as an emission length. This emission length is, for example, 30 mm. The bottom surface 227 of the cleaning unit 220 corresponds to a non-shaping region where the three-dimensional shaped article is not shaped.

In step S20, the control unit 70 controls the discharging control mechanism 154 to cause the shaping material to be ejected from the nozzle 151. The control unit 70 controls the discharging control mechanism 154 to cause the shaping material to be ejected until the shaping material ejected from the nozzle 151 is attached to the bottom surface 227 of the cleaning unit 220. That is, the shaping material is caused to be ejected from the nozzle 151 by the amount of the emission length described above. It is preferable that, at the time of ejecting the shaping material in step S20, the control unit 70 should reduce the rotational speed of the screw 110 so as to be lower than the rotational speed during the shaping process in which the three-dimensional shaped article is shaped. This configuration makes it easy to eject the shaping material straightly downward from the nozzle 151, and makes it easy to emit the shaping material from the nozzle 151 in a cleaning process that will be described later.

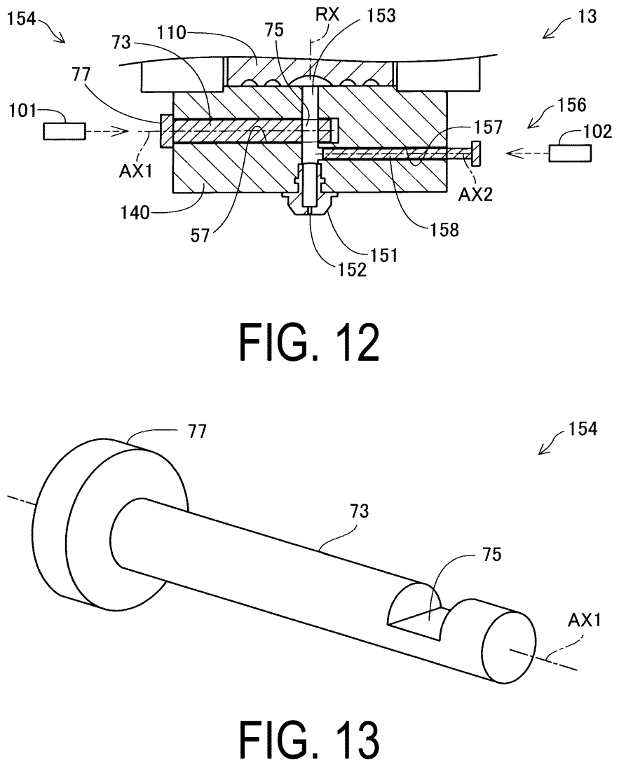

FIG. 12 is a first explanatory diagram illustrating an operating state of the ejecting unit 13. FIG. 13 is a perspective view illustrating the discharging control mechanism 154. The discharging control mechanism 154 includes a cylindrical drive shaft 73 disposed within an intersecting hole 57 that intersects the flow path 153. The drive shaft 73 is rotatable with a central axis AX1 being the center. A portion of the drive shaft 73, specifically, a recessed portion 75 functioning as a valve is formed. The recessed portion 75 is disposed at a position that makes it rotatable within the flow path 153. A coupling unit 77 is provided at a base end of the drive shaft 73. A first driving unit 101 that rotationally drives the drive shaft 73 is coupled to the coupling unit 77.

The suction-feeding unit 156 includes a branch flow path 157, and a plunger 158 disposed within the branch flow path 157. The branch flow path 157 is coupled to the flow path 153 between the discharging control mechanism 154 and the ejection port 152. The branch flow path 157 is also called a cylinder or a sleeve. The control unit 70 controls a second driving unit 102 to drive the plunger 158. The control unit 70 controls the second driving unit 102 to move the plunger 158 in a direction toward the flow path 153 along a translation axis AX2 and in a direction away from the flow path 153. The second driving unit 102 includes, for example, a stepping motor and a rack and pinion mechanism or the like configured to convert the rotational force of the stepping motor into a translation motion of the plunger 158.

In step S20, the control unit 70 controls rotation of the drive shaft 73 such that the perpendicular line to the bottom surface of the recessed portion 75 of the discharging control mechanism 154 intersects a direction in which the flow path 153 extends as illustrated in FIG. 12, thereby enabling the shaping material to flow within the flow path 153 to cause it to be ejected from the nozzle 151. In addition, the control unit 70 controls the position of the plunger 158 such that the top end of the plunger 158 is disposed at a position slightly spaced apart from the flow path 153. In the present embodiment, in step S20, the control unit 70 brings the top end of the plunger 158 into a state of being recessed from the flow path 153 into the branch flow path by 2 to 3 mm.

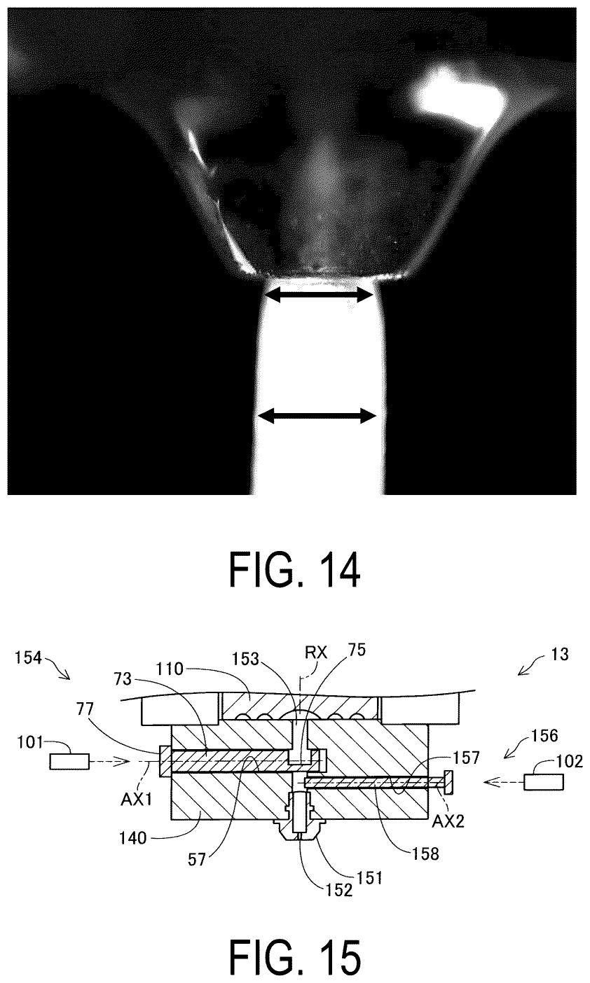

FIG. 14 is an image obtained by capturing a state where the shaping material is being ejected from the nozzle 151 in step S20. The shaping material ejected from the nozzle 151 has a diameter greater than the diameter of the nozzle 151 due to a Barus effect. The Barus effect represents a phenomenon in which, when a fluid body having a viscoelastic property flows in a capillary tube and is coming out of the capillary tube, the diameter of the flowing fluid body is greater than the inner diameter of the capillary tube at or around the outlet of the capillary tube.

In a state where the shaping material is ejected from the nozzle 151, the control unit 70 controls the discharging control mechanism 154 in step S30 of FIG. 11 to stop supplying the shaping material to the nozzle 151. In addition, after stopping supplying the shaping material to the nozzle 151, the control unit 70 performs the cleaning process. The cleaning process includes the feeding manipulation in step S40 and the suction manipulation in step S50.

FIG. 15 is a second explanatory diagram illustrating an operating state of the ejecting unit 13. In step S30, the control unit 70 controls rotation of the drive shaft 73 such that the perpendicular line to the bottom surface of the recessed portion 75 of the discharging control mechanism 154 matches a direction in which the flow path 153 extends as illustrated in FIG. 15, thereby stopping supplying the shaping material to the nozzle 151. In addition, in step S40, the control unit 70 performs the feeding manipulation to move the plunger 158 in a direction toward the flow path 153. In the present embodiment, the control unit 70 causes the plunger 158 to move in a direction toward the flow path 153 until the top end of the plunger 158 protrudes into the flow path 153. In the present embodiment, in step S40, the control unit 70 causes the top end of the plunger 158 to protrude into the flow path 153 by 0.5 to 1.5 mm. In the present embodiment, the control unit 70 controls the movement velocity of the plunger 158 such that the shaping material is extruded from the nozzle 151 at a velocity equal to or more than a velocity at the time of ejection in step S20.

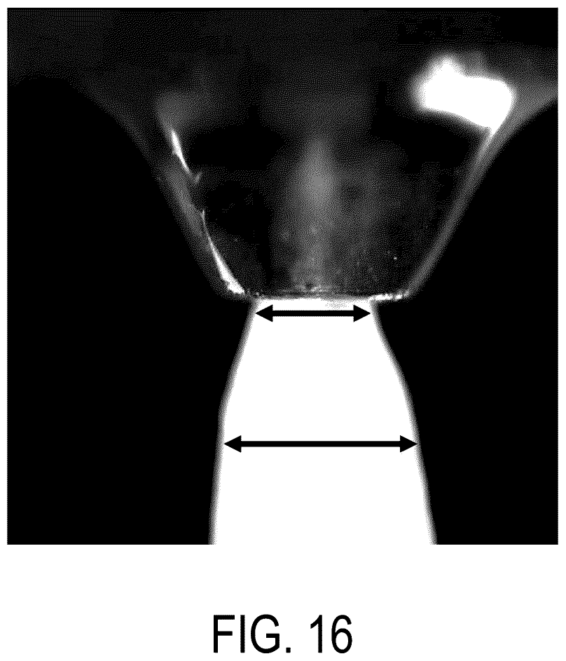

FIG. 16 is an image obtained by capturing a state where the shaping material is being ejected from the nozzle 151 in step S40. In step S40, the shaping material is extruded from the nozzle 151 at a velocity faster than the velocity at the time of ejection in step S20. Thus, the diameter of the ejected shaping material is greater than the diameter of the shaping material illustrated in FIG. 14.

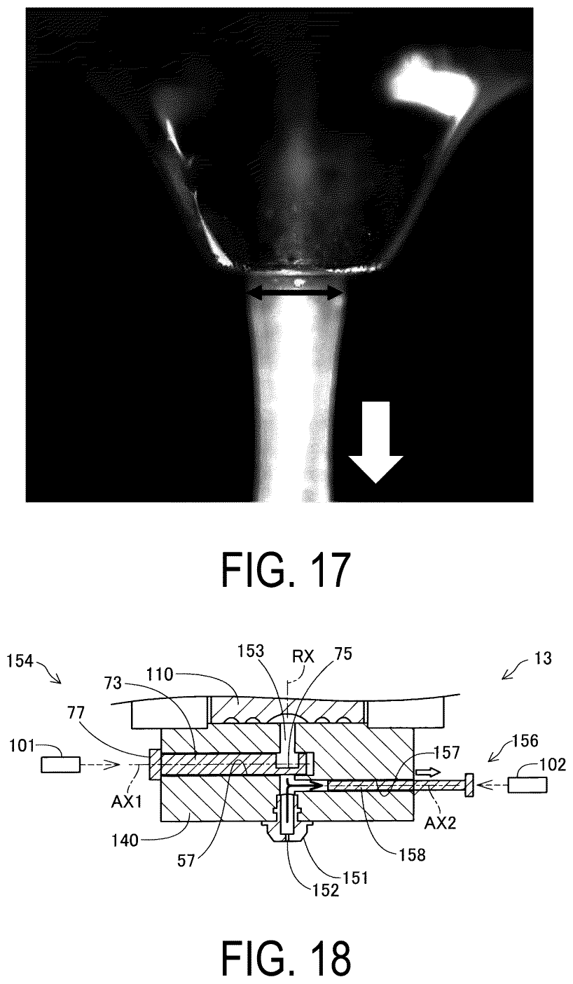

FIG. 17 is an image obtained by capturing the ejecting state of the shaping material immediately after step S40 is performed. In step S40, when the plunger 158 is caused to protrude into the flow path 153, the diameter of the shaping material ejected from the nozzle 151 immediately after this increases as illustrated in FIG. 16. However, after this, since supply of the shaping material to the nozzle 151 is stopped, the shaping material extends vertically downward from the nozzle 151 due to its own weight and the acceleration applied by the feeding manipulation in step S40 as illustrated in FIG. 17, and the diameter thereof becomes narrow.

FIG. 18 is a third explanatory diagram illustrating an operating state of the ejecting unit 13. After the feeding manipulation is performed in step S40 of FIG. 11, the control unit 70 performs the suction manipulation in step S50 to move the plunger 158 in a direction away from the flow path 153 as illustrated in FIG. 18. In the present embodiment, in step S50, the control unit 70 causes the plunger 158 to be drawn into the branch flow path 157 such that the top end of the plunger 158 is spaced apart from the flow path 153 by 5 to 6 mm.

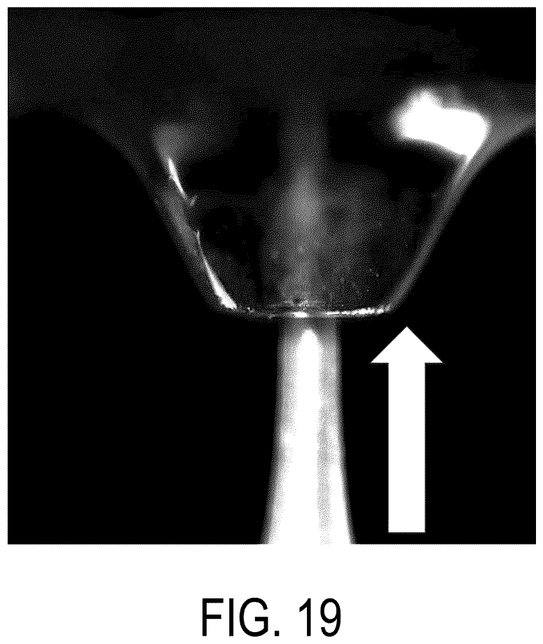

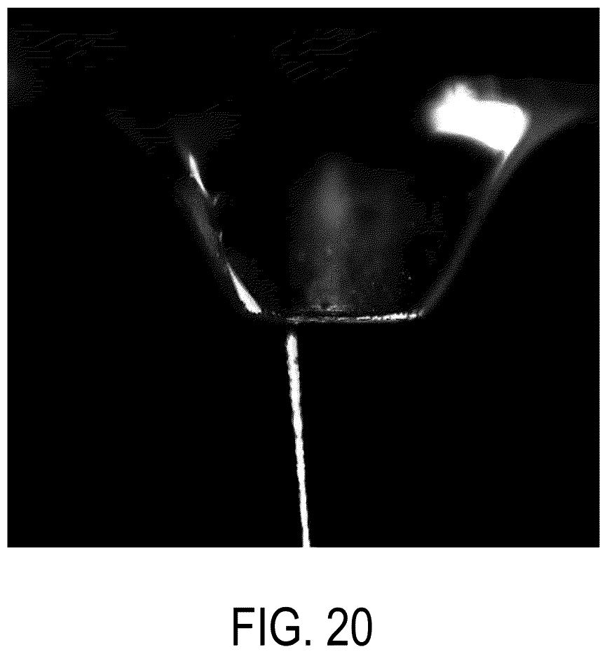

FIGS. 19 and 20 are images obtained by capturing a state where the shaping material is being sucked in step S50. Once the plunger 158 moves in a direction away from the flow path 153 through step S50, the shaping material is pulled back from the ejection port 152 into the flow path 153. With this operation, the acceleration is applied to the shaping material in a vertically upward direction as illustrated in FIG. 19, and the shaping material at or around the nozzle 151 becomes narrow. Then, finally, as illustrated in FIG. 20, the shaping material becomes further narrower, and the shaping material ejected from the nozzle 151 is separated from the nozzle 151. The separated shaping material drops into the bottom surface 227 of the cleaning unit 220, and is accommodated in the accommodation unit 222 as a waste material. The acceleration of the plunger 158 in the feeding manipulation and the suction manipulation is determined such that the inertial force determined, for example, on the basis of the own weight of the shaping material existing between the nozzle 151 and the cleaning unit 220 and the acceleration acting on this shaping material through the feeding manipulation and the suction manipulation exceeds elastic force of the shaping material.

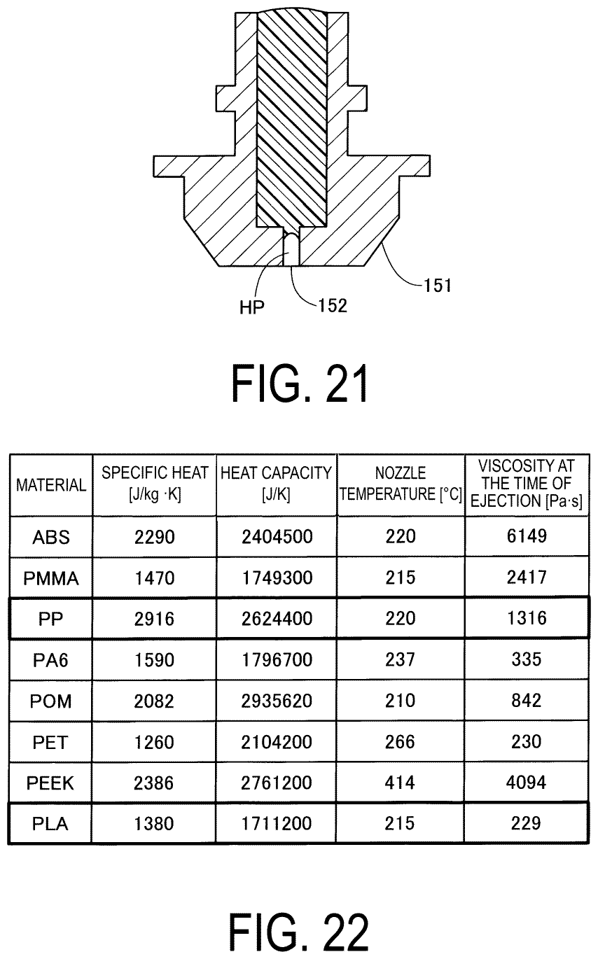

FIG. 21 is a diagram used to describe a state within a nozzle 151 after the shaping material is separated from the nozzle 151. The suction manipulation is performed in step S50 described above, whereby the shaping material is separated from the nozzle 151. This results in creation of a cavity portion HP disposed at or around the top end of the nozzle 151 and having no shaping material existing therein. Thus, through the cleaning process described above, at least a portion of the shaping material in the nozzle 151 is emitted to the outside.

It is preferable that during the feeding manipulation in step S40 and the suction manipulation in step S50, the control unit 70 should move the plunger 158 at a movement velocity faster than the movement velocity of the plunger 158 in a three-dimensional shaping process. More specifically, it is preferable that the control unit 70 should move the plunger 158 at the maximum movement velocity of the controllable velocity. By moving the plunger 158 at a high velocity during the feeding manipulation, it is possible to impart a higher acceleration in the vertically downward direction to the shaping material. In addition, by moving the plunger 158 at a high velocity during the suction manipulation, it is possible to more strongly draw the shaping material into the nozzle 151. Thus, it is possible to favorably separate it from the nozzle 151.

In step S60 of FIG. 11, the control unit 70 causes the cleaning unit 220 that accommodates a waste material to move to the emission position as illustrated in FIG. 9 to emit the waste material to the collecting unit 230. Note that, before moving the cleaning unit 220 toward the emission position, the control unit 70 may reciprocate the cleaning unit 220 at that place along the Y-axis direction by a predetermined distance and the predetermined number of times. With this configuration, when the shaping material is not completely separated from the nozzle 151, it is possible to tear the shaping material from the nozzle 151.

FIG. 22 is a diagram showing examples of the shaping material used in the three-dimensional shaping device 100. FIG. 22 shows eight types of shaping materials, the specific heat of each of the shaping materials, the heat capacity per unit volume of each of the shaping materials, temperatures of the nozzle 151 during the cleaning process, and the viscosity at the time of ejecting each of the shaping materials. The temperature of the nozzle 151 at the time of the cleaning process is equivalent to a temperature of the shaping material at the time of the cleaning process. Of the eight types of shaping materials, PP and PLA are used to perform the material emitting process using the nozzle 151 including the ejection port 152 having a diameter of 0.2 mm. In a case of PP and PLA, it does not adhere to or around the top end of the nozzle 151, and is able to be favorably separated from the nozzle 151. In addition, in a case of PP, when the material emitting process is performed using the nozzle 151 including the ejection portion 152 having a diameter of 1.0 mm, it is possible to favorably separate it from the nozzle 151. In general, as the diameter of the nozzle 151 increases, it is easier to separate the shaping material from the nozzle 151. Thus, in order to facilitate separating the shaping material from the nozzle 151, it is preferable that the diameter of the nozzle 151 should be set so as to be equal to or more than 0.2 mm, and the shaping material should include resin having viscosity equal to or more than 229 [Pa·s] and equal to or less than 1316 [Pa·s] at the temperature at the time of cleaning process.

With the three-dimensional shaping device 100 according to the first embodiment described above, the feeding manipulation and the suction manipulation are performed in the cleaning process, thereby being able to emit at least a portion of the shaping material within the nozzle 151. This eliminates the need of cleaning the nozzle 151 using a cleaning member such as a flicker plate or a brush. This makes it possible to prevent a waste material attached to the cleaning member from being attached to the nozzle 151 again, which makes it possible to suppress a reduction in the accuracy of shaping of the three-dimensional shaped article due to a waste material attached to the nozzle 151.

Furthermore, in the present embodiment, during the feeding manipulation in the cleaning process, the plunger 158 is moved toward the flow path 153 until the plunger 158 protrudes into the flow path 153. This makes it possible to efficiently impart the acceleration to the shaping material ejected from the nozzle 151. This makes it possible to favorably separate the shaping material from the nozzle 151 during the suction manipulation after this.

In addition, in the present embodiment, the cleaning process is performed after the shaping material is ejected from the ejection port 152 until the shaping material is attached to the bottom surface 227 of the cleaning unit 220. This leads to an increase in the own weight of the shaping material, which makes it easy to separate the shaping material from the nozzle 151.

### B. Other Embodiments

(B1) In the embodiment described above, during the cleaning process illustrated in FIG. 11, the control unit 70 performs both the feeding manipulation and the suction manipulation. In contrast, the control unit 70 may perform only the suction manipulation without performing the feeding manipulation.

(B2) In the embodiment described above, during the material emitting process illustrated in FIG. 11, the shaping material is emitted to the bottom surface 227 of the cleaning unit 220. In contrast, the shaping material may be emitted to a region of the stage 20 other than the region where the three-dimensional shaped article is shaped.

(B3) In the embodiment described above, during the material emitting process, the control unit 70 ejects the shaping material until the shaping material ejected from the nozzle 151 is attached to the bottom surface 227 of the cleaning unit 220. In contrast, during the material emitting process, the control unit 70 may eject the shaping material such that the shaping material ejected from the nozzle 151 is not attached to the bottom surface 227 of the cleaning unit 220.

(B4) In the embodiment described above, the control unit 70 causes the plunger 158 to move until the top end of the plunger 158 protrudes into the flow path 153 during the feeding manipulation in step S40 of the material emitting process. In contrast, the control unit 70 may shift the range of movement of the plunger 158 such that the top end of the plunger 158 does not protrude into the flow path 153 during the feeding manipulation in step S40.

(B5) In the embodiment described above, for example, when the material emitting process described above is performed to a deteriorated shaping material such as a shaping material left in the flow path 153 for a certain period of time in a high-temperature state, a shaping material that changes its quality due to heat cycle, or the like, the control unit 70 may eject a shaping material having a length longer than a normal emission length in step S20 of FIG. 11. The control unit 70 calculates the degree of deterioration of the shaping material, for example, on the basis of the temperature of the heating unit 40, the period of time for which the shaping material is left, and the number of times of turning on and off of the heating unit 40, and when the thus obtained degree of deterioration of the shaping material exceeds a predetermined threshold value, the shaping material having a length longer than a normal emission length is ejected.

(B6) In the embodiment described above, the cleaning process is performed to the nozzle 151 without using a cleaning member such as a flicker plate or a brush. In contrast, for example, it may be possible to employ a configuration in which, when the viscosity of the shaping material is greater than a predetermined threshold value, the cleaning process is performed by bringing the cleaning member into contact with the nozzle 151, and when the viscosity is equal to or less than the predetermined threshold value, the cleaning process is performed without using a cleaning member as in the embodiment described above.

(B7) In addition to being performed during the period of time when the three-dimensional shaped article is being shaped, or instead of being performed during the period of time when the three-dimensional shaped article is being shaped, the material emitting process according to the embodiment described above may be performed before first emission of a shaping material starts to shape a three-dimensional shaped article or may be performed after shaping of the three-dimensional shaped article. In addition, the material emitting process may be performed when a predetermined starting operation is performed by a user to the control unit 70.

(B8) The three-dimensional shaping device 100 according to each of the embodiments includes two heads 10. However, the three-dimensional shaping device 100 may include only one head 10, or may include three or more heads 10.

### C. Other Modes

The present disclosure is not limited to the embodiments described above, and can be achieved in various configurations without departing from the spirit of the present disclosure. For example, replacements or combinations can be made as appropriate to the technical features of embodiments that correspond to the technical features of the modes described below to solve part or all of the problems described above or to achieve part or all of the effects described above. In addition, when these technical features are not described as essential ones in the present specification, it is possible to delete the technical features on an as-necessary basis.

(1) A first mode according to the present disclosure provides a three-dimensional shaping device. This three-dimensional shaping device includes: a nozzle including an ejection port configured to eject a shaping material toward a stage where a three-dimensional shaped article is shaped; a discharging control mechanism provided in a flow path through which the shaping material flows, and configured to vary a degree of opening of the flow path to control a supply amount of the shaping material to the nozzle; a suction-feeding unit configured to perform a suction manipulation and a feeding manipulation, the suction manipulation being a manipulation of sucking the shaping material within the flow path into a branch flow path coupled to the flow path between the discharging control mechanism and the ejection port, the feeding manipulation being a manipulation of feeding, to the flow path, the shaping material sucked into the branch flow path, and a control unit configured to control the discharging control mechanism in a state where the shaping material is ejected from the nozzle, to stop supplying the shaping material to the nozzle, and then, perform a cleaning process, in which during the cleaning process, the control unit controls the suction-feeding unit to perform the suction manipulation, to emit at least a portion of the shaping material within the nozzle, to a non-shaping region where the three-dimensional shaped article is not shaped.

With such a mode, it is possible to emit at least a portion of the shaping material within the nozzle through the suction manipulation of sucking the shaping material within the flow path into the branch flow path. This eliminates the need of cleaning using a cleaning member such as a flicker plate or a brush. Thus, a waste material attached to the cleaning member is not attached to the nozzle again.

(2) The three-dimensional shaping device according to the mode described above may be configured such that the suction-feeding unit includes a plunger configured to move in the branch flow path, and in the cleaning process, the control unit moves the plunger in a direction toward the flow path through the feeding manipulation, and then, moves the plunger in a direction away from the flow path through the suction manipulation.

(3) The three-dimensional shaping device according to the mode described above may be configured such that during the feeding manipulation in the cleaning process, the control unit moves the plunger in a direction toward the flow path until the plunger protrudes into the flow path. With such a mode, it is possible to efficiently impart the acceleration to the shaping material ejected from the nozzle. This makes it possible to favorably separate the shaping material from the nozzle during the suction manipulation after this.

(4) The three-dimensional shaping device according to the mode described above may be configured such that the control unit is configured to control a movement velocity of the plunger during the suction manipulation and the feeding manipulation in each of the cleaning process and a shaping process in which the three-dimensional shaped article is shaped, and the control unit sets a movement velocity of the plunger during the cleaning process so as to be faster than a movement velocity of the plunger during the shaping process. With such a configuration, it is possible to favorably separate the shaping material from the nozzle.

(5) The three-dimensional shaping device according to the mode described above may be configured such that the control unit causes the shaping material to be ejected from the ejection port until the shaping material is attached to the non-shaping region, and then, performs the cleaning process. With such a configuration, the own weight of the shaping material ejected from the nozzle increases, which makes it easy to separate the shaping material from the nozzle.

(6) The three-dimensional shaping device according to the mode described above may be configured such that the nozzle has a diameter equal to or more than 0.2 mm, and the shaping material includes resin having viscosity equal to or more than 229 [Pa·s] and equal to or less than 1316 [Pa·s] at a temperature during the cleaning process.

The present disclosure is not limited to the modes of the three-dimensional shaping device described above, and can be achieved in various modes such as a method of cleaning the nozzle or a method of manufacturing the three-dimensional shaped article.

What is claimed is:

1. A three-dimensional shaping device comprising:
a nozzle including an ejection port configured to eject a shaping material toward a stage where a three-dimensional shaped article is shaped;
a discharging control mechanism provided in a flow path through which the shaping material flows, and configured to vary a degree of opening of the flow path to control a supply amount of the shaping material to the nozzle;
a suction-feeding unit configured to perform a suction manipulation and a feeding manipulation, the suction manipulation being a manipulation of sucking the shaping material within the flow path into a branch flow path coupled to the flow path between the discharging control mechanism and the ejection port, the feeding manipulation being a manipulation of feeding, to the flow path, the shaping material sucked into the branch flow path; and
a control unit configured to control the discharging control mechanism in a state where the shaping material is ejected from the nozzle, to stop supplying the shaping material to the nozzle, and then, perform a cleaning process, wherein during the cleaning process, the control unit controls the suction-feeding unit to perform the suction manipulation, to emit at least a portion of the shaping material within the nozzle, to a non-shaping region where the three-dimensional shaped article is not shaped.

2. The three-dimensional shaping device according to claim 1, wherein
the suction-feeding unit includes a plunger configured to move in the branch flow path, and
in the cleaning process, the control unit moves the plunger in a direction toward the flow path through the feeding manipulation, and then, moves the plunger in a direction away from the flow path through the suction manipulation.

3. The three-dimensional shaping device according to claim 2, wherein
during the feeding manipulation in the cleaning process, the control unit moves the plunger in a direction toward the flow path until the plunger protrudes into the flow path.

4. The three-dimensional shaping device according to claim 2, wherein
the control unit is configured to control a movement velocity of the plunger during the suction manipulation and the feeding manipulation in each of the cleaning process and a shaping process in which the three-dimensional shaped article is shaped, and
the control unit sets a movement velocity of the plunger during the cleaning process so as to be faster than a movement velocity of the plunger during the shaping process.

5. The three-dimensional shaping device according to claim 1, wherein
the control unit causes the shaping material to be ejected from the ejection port until the shaping material is attached to the non-shaping region, and then, performs the cleaning process.

6. The three-dimensional shaping device according to claim 1, wherein
the ejection port has a diameter equal to or more than 0.2 mm, and
the shaping material includes resin having viscosity equal to or more than 229 [Pa·s] and equal to or less than 1316 [Pa·s] at a temperature during the cleaning process.
